(19) United States
(12) Patent Application Publication
(10) Pub. No.: US 2013/0065673 A1
(43) Pub. Date: Mar. 14, 2013

(54) GAMING SYSTEM, METHOD, AND PROGRAM PRODUCT FOR REAL-TIME SELECTION OF OUTCOME DISTRIBUTION IN A WAGERING GAME

(71) Applicant: Multimedia Games, Inc., Austin, TX (US)

(72) Inventor: Brian Watkins, Austin, TX (US)

(73) Assignee: Multimedia Games, Inc., Austin, TX (US)

(21) Appl. No.: 13/631,235

(22) Filed: Sep. 28, 2012

Related U.S. Application Data
(63) Continuation-in-part of application No. 13/195,037, filed on Aug. 1, 2011.
(60) Provisional application No. 61/371,532, filed on Aug. 6, 2010.

(51) Int. Cl. A63F 13/00

(52) U.S. Cl. 463/25

(57) ABSTRACT

A method includes, for a given play of a wagering game, displaying a visual depiction which varies over a range of visual states. The visual depiction is displayed through a display system of the gaming machine and each visual state is correlated to a respective outcome distribution from a set of different outcome distributions. The method may then include receiving a player input through a player input system of the gaming machine. This player input selects one of the visual states of the visual depiction, so that the outcome distribution correlated to that selected visual state may be applied to randomly identify an outcome for a play of a game at the gaming machine. The method then includes awarding any prize correlated to the identified outcome.

### CROSS-REFERENCE TO RELATED APPLICATIONS

This application is a continuation-in-part of U.S. patent application Ser. No. 13/195,037, filed Aug. 1, 2011, and entitled “Wagering Game, Gaming Machine, Gaming System and Method With A Player-Determinable Feature Game Aspect,” which claims the benefit, under 35 U.S.C. §119(e), of U.S. Provisional Patent Application No. 61/371,532 filed Aug. 6, 2010, and entitled “Wagering Game, Gaming Machine, Gaming System and Method With A Player-Determinable Feature Game Aspect.” The Applicants claim the benefit of the above-described nonprovisional patent application under 35 U.S.C. §120 and claim the benefit of the above-described provisional patent application under 35 U.S.C. §119(e). The entire content of each of these applications is incorporated herein by this reference.

### BACKGROUND OF THE INVENTION

1. Field of the Invention

The present invention relates to wagering games, gaming machines, gaming systems, program products for such gaming machines and gaming systems, and associated methods. More particularly, the invention relates to the way in which an outcome distribution is selected for determining an outcome in a play of a wagering game.

2. Description of the Related Art

Numerous types of wagering games have been developed to provide players with new and varied gaming experiences. Providing a player interactive feature is one technique which has been used to increase player interest in wagering games. It is believed player interactive features help get the player more involved in the play of the game, and thus better hold the player's interest. One type of player interactive feature that may be employed in a gaming machine is a feature which actually or apparently gives the player an opportunity to control some aspect of a play in the game. For example, a reel-type game (a game which displays results via a number of mechanical or video-generated reels which each carry a reel strip containing a sequence of game symbols) may allow one or more of the reels to be stopped in response to a player input. A player pick-type game is another example of a player interactive game feature. U.S. Pat. No. 7,476,155 discloses a player-pick type game in which the player is allowed to pick a concealed prize from a number of different concealed prizes. The player-pick type game disclosed in this patent is controlled to ensure the selected prize is consistent with a payout distribution and expected value per play controlled by a lottery ticket set which provides outcomes for the game.

It may be desirable for regulatory purposes to ensure that a given play in a gaming machine has an outcome distribution with a predetermined expected value. Expected value in this sense is the summation of the product of each available prize in the outcome distribution and the probability of obtaining that prize. One problem that arises in a player interactive game feature that affects the prize for a given play of the game is how to allow the player interaction while still maintaining a target expected value per play. It is desirable to enforce the desired expected value per play without making the enforcement apparent to the player by the manner in which the gaming machines respond to the player interaction.

There remains a need in the field of wagering games to provide gaming machines and methods which capture and maintain the player's interest. In particular, there remains a need in the field of wagering games to provide player interactive features which help maintain the player's interest during the course of play.

### SUMMARY OF THE INVENTION

The present invention encompasses methods, apparatus, and program products for selecting an outcome distribution in the course of a wagering game based on a player input in the game. The outcome distributions may be controlled according to the invention so that each available outcome distribution produces approximately the same expected value for the play. Yet the enforcement of the desired expected value per play is not readily apparent to the player, and allows for a naturally random feel to the play of the game.

A method according to some forms of the invention includes, for a given play of the wagering game at a gaming machine, displaying a visual depiction which varies over a range of visual states. The visual depiction is displayed through a display system of the gaming machine and each visual state is correlated to a respective outcome distribution from a set of different prize distributions. The method may then include receiving a player input through a player input system of the gaming machine. This player input selects one of the visual states of the visual depiction, so that the outcome distribution correlated to that selected visual state may be applied to randomly identify an outcome for a play of a game at the gaming machine. The method then includes awarding any prize correlated to the identified outcome, with the prize being awarded through the gaming machine.

A gaming machine according to one embodiment of the present invention includes a display system including at least one display device, a player input system, and at least one processor. One or more memory devices are associated with the processor or processors for storing instructions which are executable to cause the display system to display the respective visual depiction which varies over a range of visual states. The stored instructions may also be executed to receive a player input entered through a player input system of the gaming machine to select one of the visual states and thus the outcome distribution corresponding to that visual state. The stored instructions are also executed to cause the processor or processors to apply the outcome distribution correlated to the selected visual state to randomly identify an outcome for a play of a game at the gaming machine. Ultimately, the stored instructions may be executed to cause the display system to display the award of any prize correlated to the identified outcome.

Considering that the present invention may be implemented using one or more general purpose processing devices, the invention also encompasses a program product which may be stored on one or more tangible computer readable data storage devices representing non-transitory media. The program product may include player input program code and game program code. The game program code is executable to control the display device to display the visual depiction and to apply the selected outcome distribution as described above. The player input program code is executable to receive the game play input to select one of the visual depictions and thereby select one of the available outcome distributions. Payout program code may be included in a program product embodying the principles of the invention and may be executable to award any prize correlated to the identified outcome.

These and other advantages and features of the invention will be apparent from the following description of illustrative embodiments, considered along with the accompanying drawings.

### BRIEF DESCRIPTION OF THE DRAWINGS

FIG. 1 is a view in perspective of a gaming machine which may be employed in embodiments of the present invention.

FIG. 2 is a diagrammatic representation of the gaming machine shown in FIG. 1 showing various components of the gaming machine.

FIG. 3 is a diagrammatic representation of a gaming network in which the present invention may be implemented.

FIG. 4 is a flow diagram illustrating a process flow according to one or more embodiments of the present invention.

FIG. 5 is a diagrammatic representation of a visual depiction which may be produced according to an embodiment of the invention.

FIG. 6 is a diagrammatic representation similar to FIG. 5, but showing the selection of a different visual state in the course of a game.

FIG. 7 is a diagrammatic representation of another type of visual depiction which may be produced according to an embodiment of the present invention.

FIG. 8 is a representation of another type of visual depiction which may be produced according to an embodiment of the present invention.

### DESCRIPTION OF ILLUSTRATIVE EMBODIMENTS

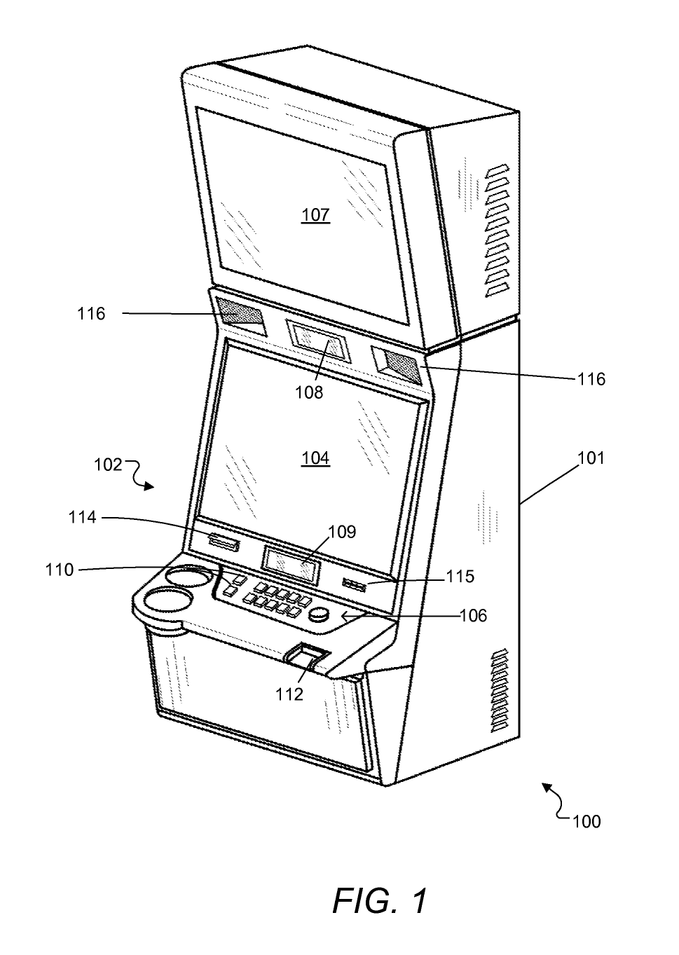

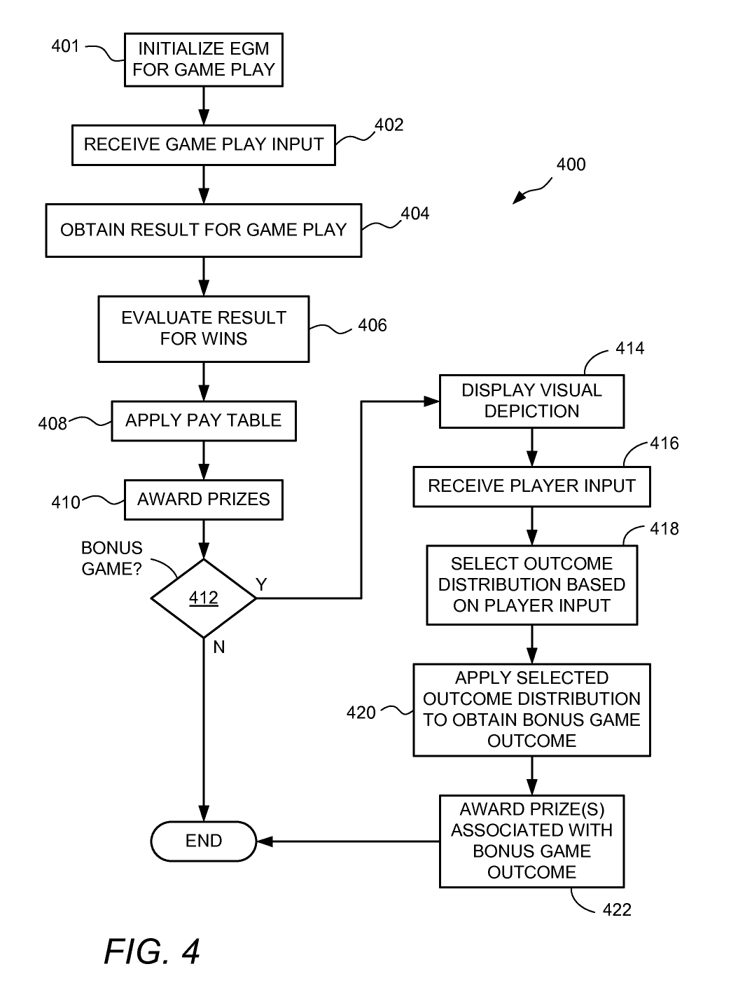

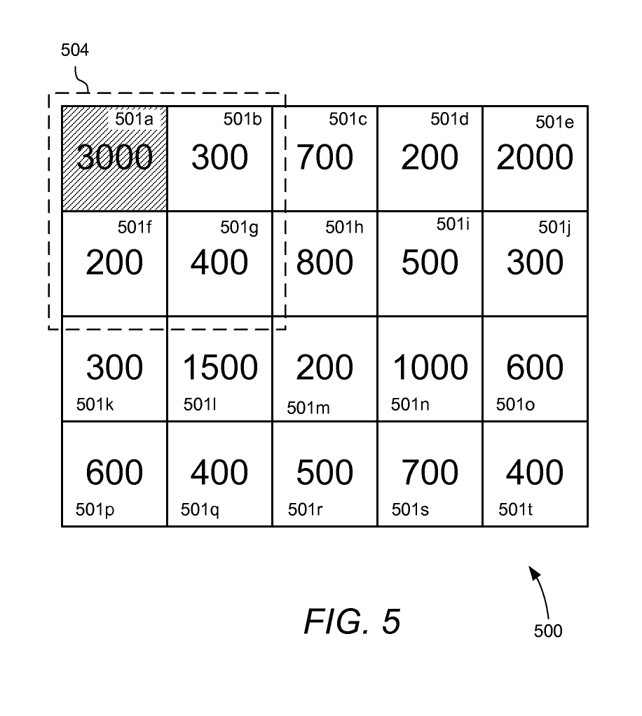

In the following description, FIGS. 1-3 will be used to describe example gaming machines and gaming networks through which the present invention may be implemented. Processes which are illustrative of certain embodiments of the invention will then be described in connection with the flow chart of FIG. 4. Various visual depictions which may be produced according to the invention will then be described in connection with FIGS. 5-8.

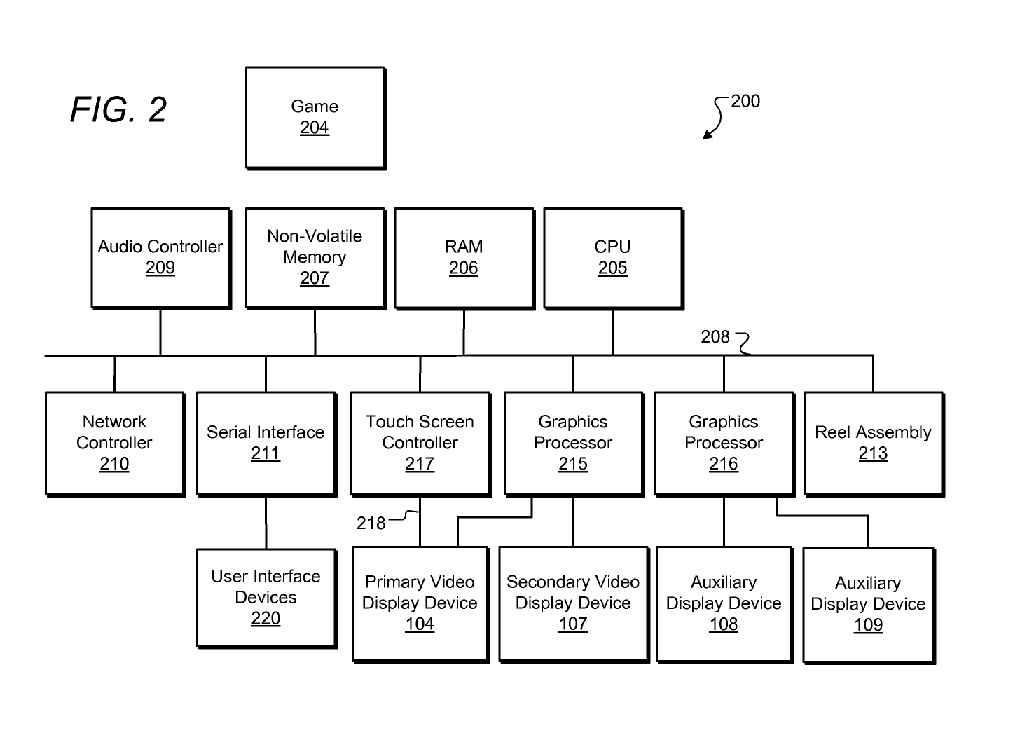

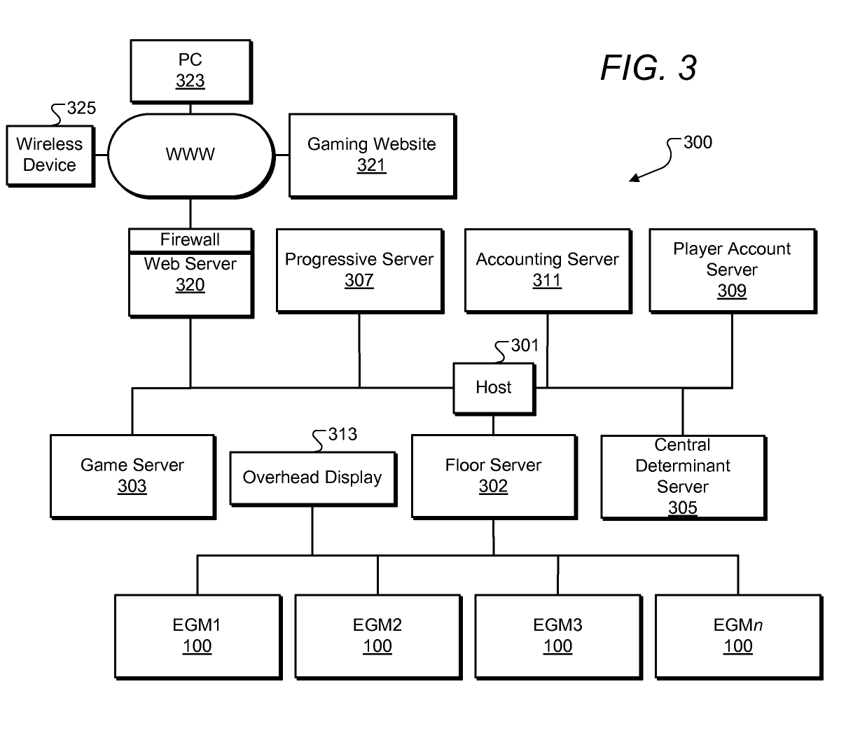

FIG. 1 shows a gaming machine 100 that may be used in implementing a game providing outcome distribution selection according to the present invention. The block diagram of FIG. 2 shows further details of gaming machine 100 along with certain variations which may be included in the gaming machine. FIG. 3 shows an example gaming network in which gaming machines such as gaming machine 100 may be employed.

Referring to FIG. 1, gaming machine 100 includes a cabinet 101 having a front side generally shown at reference numeral 102. A primary video display device 104 is mounted in a central portion of the front side 102, with a button panel 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future. One or more of these video display devices, and especially primary video display device 104, may be used to display game symbols which show the results for a given play of the game implemented through gaming machine 100. Such results may be shown by the manner in which game symbols are aligned along various paylines defined through a symbol location matrix presented by the display device. As will be described further below in connection with FIG. 2 and elsewhere, it is also possible for gaming machines within the scope of the present invention to include mechanical elements such as mechanical reels. Generally, the display device or display devices of the gaming machine, whether video display devices, mechanical devices, or combinations of the two, which are used to display games according to embodiments of the invention, may be described in this disclosure and the accompanying claims as a display system.

The gaming machine 100 illustrated for purposes of example in FIG. 1 also includes a number of mechanical control buttons 110 mounted on button panel 106. These control buttons 110 may allow a player to select a bet level, select paylines, select a type of game or game feature, and start a play in a game. Other forms of gaming machines through which the invention may be implemented may include switches, joysticks, or other mechanical input devices, and/or virtual buttons and other controls implemented on a suitable touch screen video display. For example, primary video display device 104 in gaming machine 100 provides a convenient display device for implementing touch screen controls in addition to or in lieu of mechanical controls. The player interface devices which receive player inputs to initiate the play of a game through the gaming machine, such as controls to select a wager amount for a given play and controls to actually start a given play, may be referred to generally as a player input system.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Numerous other types of player interface devices may be included in gaming machines that may be used to implement embodiments of the present invention.

A gaming machine which may be used to implement embodiments of the present invention may also include a sound system to provide an audio output to enhance the user's playing experience. For example, illustrated gaming machine 100 includes speakers 116 which may be driven by a suitable audio amplifier to provide a desired audio output at the gaming machine.

FIG. 2 shows a logical and hardware block diagram 200 of gaming machine 100 which includes a central processing unit (CPU) 205 along with random access memory (RAM) 206 and nonvolatile memory or storage device 207. All of these devices are connected on a system bus 208 with an audio controller device 209, a network controller 210, and a serial interface 211. A graphics processor 215 is also connected on bus 208 and is connected to drive primary video display device 104 and secondary video display device 107 (both mounted on cabinet 101 as shown in FIG. 1). A second graphics processor 216 is also connected on bus 208 in this example to drive the auxiliary display devices 108 and 109 also shown in FIG. 1. As shown in FIG. 2, gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself typically comprises a thin film that is secured over the display surface of the respective display device, in this case primary video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer. These elements may be mounted on a standard personal computer chassis and housed in a standard personal computer housing which itself may be mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 2 as being connected directly on system bus 208 may in fact communicate with the other system components through a suitable expansion bus. Audio controller 209, for example, may be connected to the system via a PCI or PCIe bus. System bus 208 is shown in FIG. 2 merely to indicate that the various components are connected in some fashion for communication with CPU 205 and is not intended to limit the invention to any particular bus architecture. Numerous other variations in the gaming machine internal structure and system may be used without departing from the principles of the present invention. For example, a gaming machine in some embodiments of the present invention may rely on one or more data processors which are located remotely from the gaming machine itself. Embodiments of the present invention may include no processor such as CPU 205 or graphics processors such as 215 and 216 at the gaming machine, and may instead rely on one or more remote processors. Thus unless specifically stated otherwise, the designation “gaming machine” is used in this disclosure and the accompanying claims to designate a system of devices which operate together to provide the indicated functions. A “gaming machine” may include a gaming machine such as gaming machine 100 shown in FIGS. 1 and 2, which is itself a system of various components, and may also include one or more components remote from a gaming machine cabinet (such as cabinet 101 in FIG. 1). Thus the designation “gaming machine” encompasses both a stand-alone gaming machine and a gaming machine (that is, the part housed in a cabinet such as cabinet 101 in FIG. 1) along with one or more remote components for providing various functions (such as generating outcomes for plays in a game, and driving display devices mounted in a gaming machine cabinet).

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, CPU 205 or a graphics processor packaged with or included with CPU 205 may control all of the display devices directly without any separately packaged graphics processor. The invention is not limited to any particular arrangement of processing devices for controlling the video display devices included with gaming machine 100. Also, a gaming machine implementing the present invention is not limited to any particular number of video display devices or other types of display devices.

In the illustrated gaming machine 100, CPU 205 executes software, that is, program code, which ultimately controls the entire gaming machine including the receipt of player inputs and the presentation of the graphics or information displayed according to the invention through the display devices 104, 107, 108, and 109 associated with the gaming machine. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for game software such as program code 204 (which may include the player input program code, game program code, and free play program code, and payout program code) prior to loading into random access memory 206 for execution, or for programs not in use or for other data generated or used in the course of gaming machine operation. Network controller 210 provides an interface to other components of a gaming system in which gaming machine 100 may be included. An example network will be described below in connection with FIG. 3.

It should be noted that the invention is not limited to gaming machines employing the personal computer-type arrangement of processing devices and interfaces shown in example gaming machine 100. Other gaming machines through which the invention may be implemented may include one or more special purpose processing devices to perform the various processing steps for implementing the invention. Unlike general purpose processing devices such as CPU 205, which may comprise an Intel Pentium® or Core® processor for example, these special purpose processing devices may not employ operational program code to direct the various processing steps.

The example gaming machine 100 which may be used to implement some embodiments of the present invention is shown in FIG. 2 as including user interface devices 220 (part of a player input system) connected to serial interface 211. These user interface devices may include various player input devices such as mechanical buttons shown on button panel 106 in FIG. 1, and/or levers, and other devices. It will be appreciated that the interface between CPU 205 and other player input devices such as player card readers, voucher readers or printers, and other devices may be in the form of serial communications. Thus serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

Reel Assembly 213 is shown in the diagrammatic representation of FIG. 2 to illustrate that a gaming machine which may be used for various embodiments of the invention may include mechanical reels. For example, a set of mechanical reels may replace the primary display device 104, or at least part of that display device. Alternatively, mechanical reels may be included in the gaming machine behind a light-transmissive video display panel. In either case, the mechanical reels represent a display device for displaying various game symbols in the course of a game play. Although the invention is not limited to any particular mechanical reel arrangement or control system, mechanical reels may be controlled conveniently through serial communications which provide instructions for a respective stepper motor for each reel. Thus some embodiments of the present invention which employ mechanical reels may use a serial interface device such as serial interface 211 to control communications with the reel assembly, and may not include a direct bus interconnection as indicated by FIG. 2. Details of a mechanical reel arrangement and various accent lighting arrangements which may be associated with mechanical reels are not shown in the present figures so as to avoid obscuring the present invention in unnecessary detail.

Referring now to FIG. 3, a networked gaming system 300 associated with one or more gaming facilities may include one or more networked gaming machines 100 (“electronic gaming machines” or “EGM's”) connected in the network by suitable network cable or wirelessly. Networked gaming machines 100 (EGM1-EGMn) and one or more overhead displays 313 may be operatively connected so that the overhead display or displays may mirror or replay the content of one or more displays of gaming machines 100. For example, the primary display content for a given gaming machine 100 may be stored by a display controller or game processor 205 of the given gaming machine and transmitted through network controller 210 to a controller associated with the overhead display(s) 313. In the event gaming machines 100 have cameras installed, the respective player's video images may be displayed on overhead display 313 along with the content of the player's gaming machine display.

The example gaming network 300 shown in FIG. 3 includes a host server 301 and floor server 302, which together may function as an intermediary between floor devices such as gaming machines 100 and back office devices such as the various servers described below. Game server 303 may provide server-based games and/or game services to network connected gaming devices such as gaming machines 100. Central determinant server 305 may be included in the network to identify or select lottery, bingo, or other centrally determined game outcomes and provide the information to networked gaming machines 100 which present the games to players.

Progressive server 307 may accumulate progressive prizes by receiving defined amounts, such as a percentage of the wagers from eligible gaming devices or by receiving funding from marketing or casino funds. Progressive server 307 may also provide progressive prizes to winning gaming devices in response to a progressive event. Such a progressive event may comprise, for example, a progressive jackpot game outcome or other triggering event such as a random or pseudo-random win determination at a networked gaming device or server. Accounting server 311 may receive gaming data from each of the networked gaming devices, perform audit functions, and provide data for analysis programs. Player account server 309 may maintain player account records, and store persistent player data such as accumulated player points and/or player preferences (for example, game personalizing selections or options).

Example gaming network 300 also includes a gaming website 321 which may be hosted through web server 320 and may be accessible by players via the Internet. One or more games may be displayed as described herein and played by a player through a personal computer 323 or handheld wireless device 325 (for example, a Blackberry® cell phone, Apple® iPhone®, personal digital assistant (PDA), iPad®, etc.). To enter website 321, a player may log in with a user name that may, for example, be associated with the player's account information stored on player account server 309. Once logged onto website 321 the player may play various games on the website. Also website 321 may allow the player to make various personalizing selections and save the information so it is available for use during the player's next gaming session at a casino establishment having the gaming machines 100.

It will be appreciated that gaming network 300 illustrated in FIG. 3 is provided merely as an example of a gaming network in which games featuring outcome distribution selection according to embodiments of the present invention may be implemented, and is not intended to be limiting in any way. The invention is not limited to use in games offered through a gaming network (via the gaming website 321, or via gaming machines such as gaming machines 100, or otherwise). For example, games including outcome distribution selection according to the present invention may be offered through a stand-alone gaming machine having a configuration similar to gaming machine 100 or having any other gaming machine configuration. Also, where games including outcome distribution selection as described particularly below in connection with FIGS. 4-7 are offered through gaming machines included in a gaming network, the network need not have the configuration shown for purposes of example in FIG. 3. In particular, servers shown separately in the example of FIG. 3 may be combined in a single physical processing device, or the processing duties of the various illustrated servers may be split into additional physical devices.

FIG. 4 illustrates an example process within the scope of the present invention. The process shown in FIG. 4 from process block 402 through 422 represents a single game play sequence according to one form of the invention and thus may be repeated for each activation of the game. The following paragraph will describe the overall process shown in FIG. 4 and then subsequent paragraphs will describe the individual process steps in greater detail, and describe certain variations on these steps.

As shown at process block 401, the electronic gaming machine (such as gaming machine 100 in FIGS. 1-3) is first initialized for game play. Once the gaming machine is initialized, the process may include receiving a game play input as indicated at process block 402, and then obtaining a result for the game play as indicated at process block 404. Once the result is obtained and typically displayed at the gaming machine, the process includes evaluating the result to identify any winning aspects of the result as indicated at process block 406. In this illustrated example, the process then applies the applicable pay table as indicated at process block 408, and awards prizes defined in the pay table for any detected winning aspects of the result as indicated at process block 410. If no bonus game is awarded either from the result obtained at process block 404 or otherwise as indicated by a negative outcome at decision box 412, the process ends. However, if a bonus game has been awarded as indicated by an affirmative outcome at decision box 412, the process branches to conduct the bonus game. The bonus game in this embodiment includes displaying a visual depiction according to the invention as indicated at process block 414, and then receiving a player input to select one of the visual states of the visual depiction as indicated at process block 416. The process then includes selecting an outcome distribution based on the player input as shown at process block 418 and then applying that selected outcome distribution to obtain an outcome for the bonus game at process block 420. Any prizes associated with the bonus game outcome are awarded as shown at process block 422 and the process then ends for the game play sequence. As noted above, the process steps from 402 to 422 may be repeated for each subsequent game play input or activation in a gaming session by a player at the gaming machine.

It is apparent from the example process shown in FIG. 4 that the outcome distribution selection according to the present invention is included in the play of the bonus game in a cycle through process blocks 414, 416, 418, 420, and 422. However, it will be appreciated that the invention is not limited to bonus games or any other level of game provided through a gaming machine. For example, the process of obtaining a result for the game play as indicated at process block 404 may include an outcome distribution selection according to the present invention. In this case the evaluation indicated at process block 406 and the pay table application at process block 410 may or may not be required depending upon the nature of the game. In any event, it should be appreciated that the example process 400 of FIG. 4 is shown just for providing an example game in which outcome distribution selection may be employed according to the invention, and for describing an application of the invention in a specific context.

The process of initializing a gaming machine for play of the game as indicated at process block 401 may include a number of different steps depending upon the nature of the gaming machine and the gaming network in which the gaming machine may be included. For example, many modern gaming machines may require a player login to initialize the gaming machine for play. This login may include receiving a player identifier at the game machine in some fashion either through a card reader or other reading device or input device at the gaming machine. Other gaming machines may require no player login, but may require the player to insert cash or credits into the gaming machine in some fashion to initialize the gaming machine for play. For example, in ticket-in-ticket-out systems, a player may be required to insert a ticket into a ticket reader at the gaming machine to place credits on the gaming machine to facilitate play. Where the gaming machine accepts cash, the initialization process may include receiving cash from the player. Process block 401 is included in FIG. 4 simply to indicate that typically the gaming machine must be initialized for game play in some fashion, but is not intended to limit the invention to any particular type of initialization.

In some forms of the invention the process of initializing the gaming machine for play as indicated at process block 401 causes the gaming machine to display a symbol display area on a symbol display device of the gaming machine. The symbol display area includes a number of symbol locations for a wagering game, such as the symbol locations used to show results in a reel-type game for example. The state of this symbol display area (that is, the particular game symbols displayed in the symbol locations) may simply be left over from the immediately preceding play of the game. In other embodiments, the state of the symbol display area may be left over from an attract sequence executed by the gaming machine to attract a player to that particular machine. Yet other forms of the invention may return the symbol display area to a particular starting condition for each play of the game.

The game play input received as indicated at process block 402 may include receiving a number of separate inputs to initiate the play of the game. For example, a player may be required to select a bet level for the play and/or may be required to select which symbol location combinations (paylines in reel-type games) are active for the given play. The present invention is not limited to receiving any particular input or inputs to initiate the play of the game. Unless stated specifically otherwise, for the purpose of this disclosure and the following claims, the step of receiving a game play input includes receiving any single input or sequence of inputs to initiate the play of the game.

It should also be noted that the sequence of receiving a game play input as shown at process block 402 in FIG. 4, and obtaining a result as indicated at process block 404, is subject to variation within the scope of the present invention. In some implementations, the result for a given game play may be obtained prior to any game play input.

Where the initial game conducted in process 400 is a reel-type game, the process of obtaining a result as indicated at process block 404 may include populating the various symbol locations of a symbol location matrix for the game with respective game symbols. Where the gaming machine includes mechanical reels, at least some symbol locations may be populated by spinning the reels and then bringing each reel to a stop to show a respective game symbol at each symbol location. Video reel-type games may include a video simulation of reels (which may be shown on video display device 104 in FIG. 1 for example) which spin and then come to a stop to show various game symbols in the symbol location matrix. The invention is not limited to any particular reel arrangement, for either a mechanical reel or video reel implementation. Also, some video-implemented forms of the invention may populate the symbol location matrix without showing reels spinning. The selected game symbols may simply appear in some fashion in the various symbol locations of the matrix.

It should be appreciated that some forms of the invention may not change all of the game symbols used to show a result for a given play of the game. For example, one or more of the mechanical or video-generated reels in a reel-type game may remain stationary for a given play. Such stationary reels may be selected randomly, may be selected under the control of the player in some fashion, may be selected based on a previous play of the game, or may be selected in any other fashion. Where the player may select symbol locations to remain constant over the course of the given play of the game, the selection may be part of the game play input at process block 402, for example.

The invention is not limited to any particular arrangement for selecting the game symbols to be displayed in the various symbol locations in games that utilize such a symbol location matrix to display results for a given play of the game. Any selection arrangement that selects each game symbol may be used within the scope of the invention. For example, in reel-type games each reel may be associated with a reel weighting which includes an overall numeric range made up of a respective numeric subrange for each symbol on the respective reel strip shown on that reel. Each numeric subrange is selected to provide the desired fraction with respect to the overall numeric range. This desired fraction represents the probability of the reel strip landing (stopping) at a stop position or zero position at that reel symbol. For each play of the game, the symbol to display at the stop position or zero position for the given reel may be obtained by generating a random number within the overall numeric range, and then identifying the numeric subrange in which that random number is included. The reel is then controlled to stop showing the reel symbol corresponding to that numeric subrange at the stop position or zero position for the reel. Alternatively, in a central determinant system, such as a central determinant bingo or electronic lottery system, for example, a given play of the game may be associated with one or more outcomes of the underlying game. In these cases, each reel of a reel-type game may be forced to stop at the desired angular orientation to display game symbols consistent with the outcome of the underlying game or a random outcome selection. In other forms of the invention the outcome for a given play of the game is obtained in some fashion at the gaming machine itself and the reels are forced to stop showing game symbols consistent with the outcome.

The process of evaluating the result for wins as shown in process block 406 in FIG. 4 may be accomplished in any suitable fashion consistent with the nature of the game for which the result is obtained at process block 404. For a reel-type game the evaluation may involve comparing the various game symbols in the game symbol matrix to the winning symbol combinations defined in an applicable pay table for the game to determine if a given displayed game symbol matrix matches any of the winning symbol combinations defined in the pay table. The game symbols appearing in the game symbol matrix may be apparent from the angular position of the reel or virtual reel, or may be apparent from the result which forces the reels to stop at the given positions. Alternatively, each winning symbol combination defined in the pay table may be correlated to a set of reel stop positions which produce the symbol combination, and these reel stop positions may be stored in a data table. In this alternative, the evaluation may include comparing the reel stop positions for the game symbol matrix to the stored reel stop positions to identify a match. Such a match indicates that the game symbol matrix produces the winning symbol combinations or combinations correlated to the matched reel stop positions.

The processes of obtaining the result indicated at process block 404 and evaluating the result at process block 406 will vary significantly depending upon the game being played. For example, where the game is a player picking game in which the player picks from among a number of concealed prizes, obtaining a result at process block 404 may include receiving the player selection, and then evaluating the result at block 406 may include reading the prize associated with the player selection. In this case it may not be necessary to apply any pay table as indicated at process block 408, and the process may simply include awarding the selected prize at process block 410. As a further example, where the game played according to the sequence of blocks 402, 404, 406, 408, and 410 in FIG. 4 is a playing card game such as a poker game, the process of obtaining a result may include randomly selecting cards for the playing card hand. The evaluation at process block 406 in this case may be to evaluate the resulting playing card hand for winning card combinations.

The process of applying the pay table or pay tables for winning symbol combinations according to process blocks 408 may involve any process suitable to the game being played. For example, each winning symbol combination detected in a reel-type game may be associated with a prize value through a suitable data table. In this case, applying the pay table involves reading the associated prize value from the data table and adding that winning prize amount (in the applicable units) to a total amount for that play of the game. In the case of a playing card game, applying the pay table at process block 408 may include looking up the prize correlated to any winning hand that has been detected.

The prizes that may be awarded in accordance with process blocks 410 and 422 may be awarded in any particular fashion consistent with the particular gaming machine and gaming system. For example, prizes are awarded in some gaming machines by increasing the credit value on the gaming machine and the player may cash out from that gaming machine to obtain value for those credits. Other types of gaming systems maintain an account for the player's play at a remote accounting system, and the prizes are awarded by crediting the player's remote account and showing the updated account value at the gaming machine. Some types of prizes may be hand pay prizes which require a casino employee to manually deliver the prize or a voucher for the prize to the player. Hand pays are typically required for high-value prizes or for prizes in the form of merchandise or coupons. Other types of gaming machines may physically dispense prizes in the form of coins or other value. The invention is not limited to any particular system or arrangement for awarding the prizes for wins according to the applicable pay table or pay tables for the game.

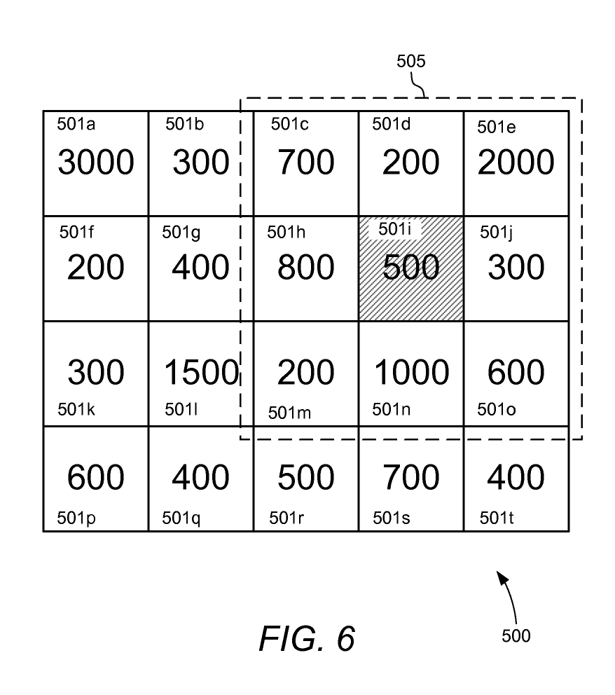

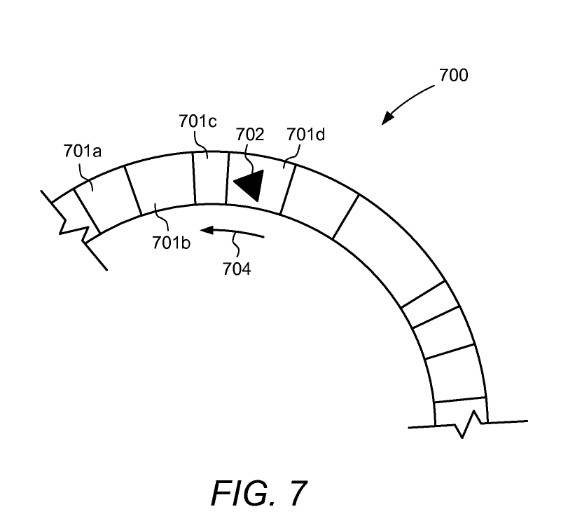

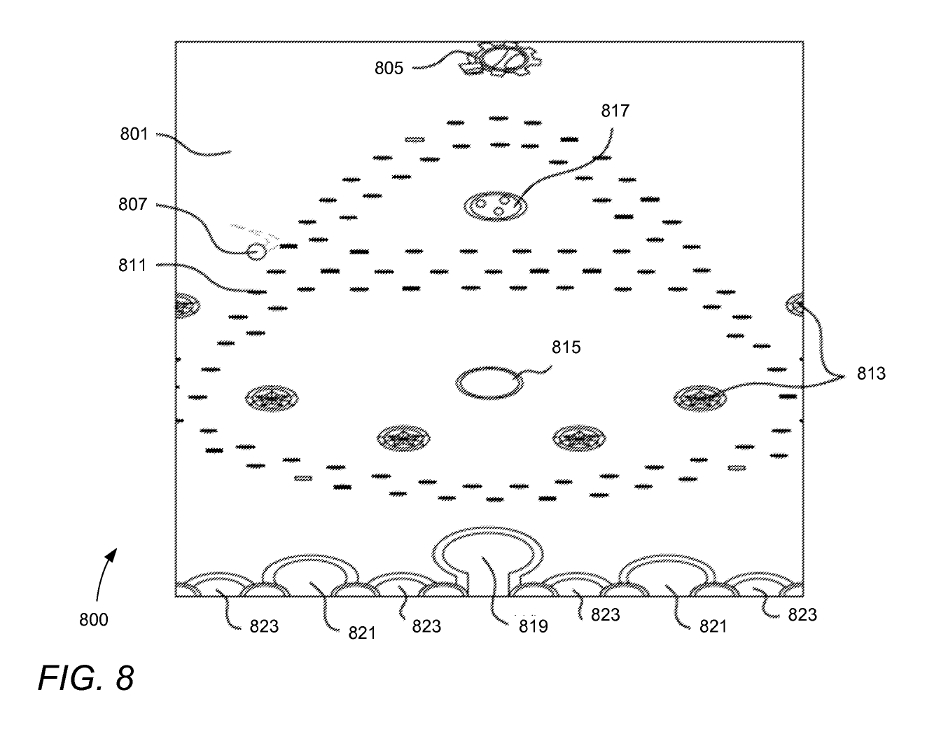

The visual depiction which may be displayed according to the invention at process block 414 may comprise any number of visual depictions which vary across various visual states. One example visual depiction includes an element which oscillates back and forth across a range of angular orientations. The specific example described below in connection with FIG. 8 provides an example of a visual depiction including such an oscillating element. In other visual depictions an element may travel along a path in which various different positions along the path are each correlated to a visual state. The specific example described below in connection with FIG. 7 provides an example of a visual depiction including an oscillating element which travels along a path. Another type of visual depiction may include a target area that traverses a field of locations. In this type of depiction each location in the field may be correlated to a visual state in the field. The specific example described below in connection with FIGS. 5 and 6 provides an example of a visual depiction including a target area traversing a field of various locations.

In each type of visual depiction according to the invention each different visual state will be correlated to a respective outcome distribution in some fashion. The outcome distributions may be arbitrarily assigned to the various different visual states, or may be assigned based on other adjacent visual states in the depiction, for example. The example described below in connection with FIGS. 5 and 6 provides an example of the latter arrangement for assigning outcome distributions. In any event, some preferred forms of the invention ensure that each of the outcome distributions that are employed to determine some payout in the game have approximately the same expected value. “Approximately the same” in this sense may mean equal within hundredths of a credit (or other prize value unit). In some cases expected values that are approximately the same may be defined by regulation. Of course, the invention is not limited to the case where all of the prize distributions have approximately the same expected value.

The player input received as indicated at process block 416 may be any sort of input received in any sort of fashion to select one of the visual states of the visual depiction displayed at process block 414. Various types of inputs and selection processes will be described below in connection with the example visual depictions. For example, the player input may comprise a touch of a touch screen which displays the visual depiction, or may be an input from a cursor control device which controls the position of a cursor on a video display showing the visual depiction. Regardless of the type of input received at process block 416, that input is used in some fashion at process block 418 to select one of the visual states and thus select an outcome distribution correlated to that selected visual state. In some cases a data table may store a correlation between each visual state of the visual depiction and a respective outcome distribution. In these cases, the selection at process block 418 may include performing a lookup of the selected visual state in the data table and reading the outcome distribution or a handle for the distribution from that location in the data table.

Once an outcome distribution is selected it may be applied in any suitable fashion to obtain a result in the given game. One preferred arrangement is similar to the arrangement for determining a reel stop position in a reel-type game as described above. In this preferred arrangement, an overall numeric range is designated and each outcome in the selected prize distribution is associated with a respective numeric subrange within the overall numeric range. Each numeric subrange correlates to a probability of achieving that outcome on a given play, and the numeric subranges sum to the overall numeric range. Selecting an outcome in this arrangement includes generating a random number within the overall numeric range and then determining which numeric subrange contains the generated random number. The outcome associated with that particular numeric subrange is the outcome assigned for the play of the game.

As will be discussed below in connection with the example of FIG. 8, not all outcomes obtained according to the invention at process block 420 will be directly related to a prize in the game. Rather, some outcomes obtained according to the invention will specify parameters from which one or more prizes in the game may be determined. Regardless of how any prizes in the game are determined, directly or indirectly from the outcome obtained at process block 420, the prizes awarded as shown at process block 422 in FIG. 4 may be awarded in any suitable fashion consistent with the gaming machine and accounting system through which the game is implemented. These awarding methods include all of the methods described above particularly in connection with process block 410.

FIGS. 5 and 6 both relate to a visual depiction which is produced in a game implementing the present invention according to the step indicated at process block 414 in FIG. 4. FIG. 5 provides one example and FIG. 6 provides another example using the same field or grid-type visual depiction. FIGS. 5 and 6 both show a grid 500 segmented into a number of different grid locations 501a-501t. Each of the grid locations 501a-501t in FIGS. 5 and 6 is associated with a respective prize value, shown in this example as a respective numeric value of some suitable unit. As part of the visual depiction including grid 500, a light illuminates a target area of the grid, and this illuminating light traverses the grid passing over the various grid locations either randomly or in any suitable fashion. For purposes of the example shown in FIGS. 5 and 6 the illuminated grid location at the given point in time of the respective illustration is shown by crosshatching in the respective grid location. Thus, grid location 501a is illuminated in the visual state shown in FIG. 5 and grid location 501i is illuminated in the visual state shown in FIG. 6. Furthermore, the visual depiction illustrated in the examples of FIGS. 5 and 6 includes twenty different visual states, one visual state corresponding to each grid location being illuminated. Preferably the illuminating light passes over the various grid locations 501a-501t rapidly so that a single grid location is illuminated by the light for only a short period of time before moving on to another grid location. In some implementations of the visual depiction shown in FIGS. 5 and 6 all of the other grid locations which are not illuminated at a given point in time by the illuminating light may be obscured so that the respective prize values are not visible to the player. In other implementations, some or all of the grid locations not covered by the illuminating light, and the respective prize values for those grid locations, may be visible to the player throughout the game and the area of illuminating light may serve simply to identify the target area.

In the examples of FIGS. 5 and 6 the player input received at process block 416 in the example process of FIG. 4 may select the particular grid location which is illuminated as a target area at the time the player selection is received. However, this player selection of a particular grid location does not itself dictate any prize, particularly the prize value associated with the selected grid location. Rather, in this example implementation, the player's selection of a grid location in accordance with process block 416 in FIG. 4 selects a prize distribution defined by the selected grid location and each adjacent grid location. That is, the player's selection of grid location 501a in FIG. 5 defines a prize distribution made up of the prizes at grid locations 501a, 501b, 501f, and 501g (shown in dashed box 504 in the figure). The probabilities associated with the different prizes of the distribution may be preconfigured for that visual state shown in FIG. 5 to produce a predetermined expected value for the player's selection. For example, the following prize distribution correlated to the visual state of FIG. 5 provides an expected value of 700 units (the sum of each prize amount multiplied by its respective probability).

| Prize | Probability | Grid Location |
|---|---|---|
| 3000 | 0.15 | 501a |
| 400 | 0.25 | 501g |
| 300 | 0.3 | 501b |
| 200 | 0.3 | 501f |

With a prize distribution now selected by the player's input to select location 501a, an outcome may now be selected using the prize distribution in accordance with process block 420 in FIG. 4. Any suitable process may be used to enforce this prize distribution in the prize selection. A preferred process comprises the random number and numeric range/subrange technique discussed above in connection with process block 420. Regardless of the technique applied to obtain an outcome from this prize distribution, when one of the prizes is selected, the visual depiction is preferably controlled to cause the target area specified by the illuminating light to move quickly to illuminate and stop on the grid location corresponding to the selected prize. For example, if the prize and thus grid location selected from the above prize distribution is prize 300 units at grid location 501b, then the illuminating light would move quickly to grid location 501b and stop at that grid location to indicate to the player that they have won that particular prize value. The speed at which the illuminating light may move once the prize is determined may be the same speed the illuminating light moved before the prize selection, or perhaps a faster speed.

It should be noted in the example of FIG. 5 that even though the player selection occurred when the light illuminated the 3000 unit prize at grid location 501a, that player input did not necessarily lead to an award of that prize value. Rather, the player input defines the outcome distribution, in this case a prize distribution, which is then used according to process block 420 in FIG. 4 to obtain the outcome for the play. Thus the outcome for the play indicated in the example of FIG. 5 may be the prize associated with any of grid locations 501a, 501b, 501f, and 501g according to the respective probabilities of obtaining each of those prizes.

FIG. 6 shows the same grid 500 but with the target area/illuminating light at a different location in the grid. In this example, the illuminating light is directed to location 501i, and it is assumed that this is the actual location of the illuminating light at the time of the player input in accordance with process block 416 in FIG. 4. This particular visual state shown in FIG. 6 defines nine grid locations which each specify a prize for the prize distribution to be used for this play. The nine grid locations are shown in dashed box 505. As with the previous example, the player's input received while the visual depiction is in the visual state shown in FIG. 6 defines the prize distribution to be used to obtain an outcome for the play of the game. Also as with the previous example, the prize distribution for this particular visual state may be predefined and stored to produce the same expected value for the play. This is the case even though there are more potential outcomes and different outcome values in the case of FIG. 6. In particular, the following prize distribution having an expected value of 700 units may be used for a selection of the visual state shown in FIG. 6.

| Prize | Probability | Grid Location |
|---|---|---|
| 2000 | 0.1 | 501e |
| 1000 | 0.1 | 501n |
| 800 | 0.1 | 501h |
| 700 | 0.15 | 501c |
| 600 | 0.15 | 501o |
| 500 | 0.1 | 501i |
| 300 | 0.15 | 501j |
| 200 | 0.15 | 501m |

Again it should be noted that even though the player input was received when the illuminating light was at the location 501i for the example of FIG. 6, the actual prize which may be selected according to the prize distribution may be any of the prizes associated with locations 501c, 501d, 501e, 501h, 501i, 501j, 501m, 501n, and 501o. As with the example of FIG. 5, once the prize is selected according to the applicable prize distribution, the target area/illuminating light quickly moves to the grid location correlated to the selected prize and stops at that grid location to indicate to the player that they have won that prize.

It will be appreciated that the prize distribution selection technique applied in the examples of FIGS. 5 and 6 results in a more smooth and natural movement of the target area/illuminating light than would be the case if a prize distribution encompassing all of the grid locations were used. This is so because in the latter case it is possible that for a given play a prize could be selected that happened to be far away from the location of the target area at the time of the player input, and such an occurrence would require that the illuminating light jump quickly from the location at the time of the player input to the location of the selected prize. Because the prize distribution in the examples of FIGS. 5 and 6 is made up only of prizes in locations adjacent to the location actually selected by the player input, and assuming the target area/illuminating light travels fairly rapidly across grid 500, and perhaps in a somewhat jittery fashion, it should not be apparent to the player that their input did not dictate the stopping position of the target area/illuminating light. Yet the result of the play is selected at random within the confines of the selected prize distribution, so that in preferred embodiments the expected value of the game can be made invariant with respect to player behavior.

Although the form of the invention shown in FIGS. 5 and 6 uses only adjacent grid locations in defining the prize distribution set, other embodiments may use grid locations that are two or more locations away from the selected location. If the locations are sufficiently close together and if the speed of the target area is sufficiently high, including more grid locations to define the distribution will not interfere with the apparent natural movement of the target area.

FIG. 7 shows another visual depiction which may be shown at process block 414 in FIG. 4 according to an embodiment of the present invention. This visual depiction 700 includes a portion of a circular path divided into various segments 701a, 701b, 701c, 701d, and so forth. Each of the segments 701a-701d may be associated with a respective outcome for the play of the game. Although no prize values are shown in the various segments of FIG. 7, it will be appreciated that various embodiments may show prize values in the segments 701a, etc. so as to be plainly visible to the player. In the course of the visual depiction, indicator 702 travels preferably rapidly along the circular path in the direction shown by arrow 704, and the player input (received according to process block 416 FIG. 4) selects a visual state comprising the location of the indicator 702 along the path. This location may in turn by used to define an outcome distribution to be used in determining the outcome for the play of the game. For example, where the indicator 702 travels rapidly along the path, the prize distribution may be defined to include the prize associated with the segment in which the center of the indicator is located at the time of the player input plus the prizes associated with the next three segments along the path. In the illustrated example, the player's input occurs when indicator 702 is at segment 701d and thus the prize distribution would include the prizes associated with segments 701d, 701c, 701b, and 701a. The probabilities associated with each of these segments may be controlled as described in connection with FIGS. 5 and 6 to provide a common expected value regardless of when the player makes their input. Also as with the example of FIGS. 5 and 6, once the prize value for the play is obtained by applying the prize distribution effectively selected by the player input, the indicator may be controlled to stop at the segment showing that prize value. This control of the indicator 702 allows the timing of the player input to dictate a subset of the available prizes which may possibly be awarded, followed by a random determination of which of those prizes is actually awarded.

It will be appreciated that although FIG. 7 is described above as having an indicator that moves relative to the path, the invention is not limited to this sort of movement. In other forms of the invention, an indicator may be stationary and the path may move relative to the indicator. In this way, the invention may be applied to a prize wheel divided into segments showing various prizes.

In the examples of FIGS. 5-7, the outcome distribution selected by the player input includes the prize correlated to the location of the target area/illuminating light (in FIGS. 5 and 6) and the indicator 702 (in FIG. 7) at the time of the player input. Other embodiments of the invention may not include in the selected outcome distribution the prize correlated to the location of the target area/illuminating light or indicator at the time of the player input. Particularly in embodiments where some element such as indicator 702 in FIG. 7 travels continuously (or sporadically) along a path, it may be desirable to include in the selected outcome distribution only those prizes which are associated with path segments one or more segments removed in the direction of movement from the location of the indicator at the time of the player input. In the case of FIG. 7 for example, even though the player input may be received when indicator 702 is at segment 701d, the outcome distribution employed to randomly select a prize for the play may include the prize associated with segment 701a and the prizes associated with the next three or four segments in the direction of movement of indicator 702 depending upon the speed at which indicator 702 travels and the length of the different path segments. This allows more time for the random determination of the prize from the selected outcome distribution and may allow for a more natural depiction of the indicator coming to a stop in response to the player input.

FIG. 8 provides another type of visual depiction which may be displayed in accordance with process block 414 in the example process of FIG. 4. This visual depiction 800 includes launcher 805 which may launch a projectile, such as ball 807. Each ball 807 that is launched for a play of the game may accumulate a score achieved as the ball encounters targets along its respective path. Various targets may be shown in visual depiction 800 and may include pins 811 (which may have an associated prize, such as 5 credits, for every pin 811 struck by ball 807), bumpers 813 (which may have an associated prize, such as 25 credits, for every bumper 813 struck by ball 807). Other obstacles include ball catcher 815 (which when struck by ball 807 may temporarily capture the ball and launch a mini-game, such as by opening a window with a spinning wheel or mini-set of spinning reels resulting in an outcome). An award associated with ball catcher 815 may be based on the mini-game outcome. Once the mini-game is complete, ball catcher 815 may release ball 807. Another obstacle, multi-ball launcher 817 may cause one or more additional balls 807 to launch when the original ball 807 encounters the multi-ball launcher, and each of the balls 807 may strike targets and accumulate more prizes. A visual depiction such as that shown in FIG. 8 may also include a chute (not shown) which when entered by a ball 807 may launch the ball upward. The illustrated visual depiction shown in FIG. 8 also includes buckets (bubbles) 819, 821, and 823 which balls 807 may encounter to accumulate additional prizes. Each of the buckets 819, 821, and 823 may be associated with a respective associated prize, such as 100 credits for bucket 819, 50 credits for bucket 821, and 25 credits for bucket 823.

The ball launcher 805 shown in FIG. 8 may continuously oscillate back and forth across a range of angular orientations, each orientation representing a visual state comprising a launch direction for ball 807. The player input received as indicated at process block 416 in FIG. 4 may be used to select a visual state of ball launcher 805 comprising a particular angular orientation. Each angular orientation may be correlated to an outcome distribution comprising a number of launch velocities, each correlated to a probability of being selected for the given play. Thus the selection of an angular orientation of ball launcher 805 by the player input selects the outcome distribution comprising the various launch velocities correlated to the angular orientation. This selection of outcome distributions corresponds to the step shown at process block 418 in FIG. 4. The trajectory of the ball 807 and the various targets encountered may also be dictated by the selected launch angle and the respective launch velocity of the outcome distribution so that each velocity in the outcome distribution is also associated with a specific prize. Thus the step of applying one of the launch velocities in the distribution of different launch velocities has the effect of determining a prize for the launched ball. This prize may be tabulated as the ball traverses the field of targets, and then may be awarded in accordance with the step shown at process block 422 in FIG. 4.

It will be noted that the application of the outcome distribution technique in the arrangement of FIG. 8 does not appear to the player to select a particular prize in the same fashion as the examples of FIGS. 5-7. That is, the launch angle which the player selects by the input received at process block 416 in FIG. 4 does not appear to the player to be associated with a given prize in the sense that a visible prize is associated with each launch angle (visual state). This is in contrast to the examples of FIGS. 5-7 in which it appears to the player that their input is applied to stop the indicator (illuminated target area or indicator 702) at a given prize. Although the implementation illustrated in FIG. 8 does not appear to associate the player input to a specific visible prize, it does provide the benefit of randomly varying the trajectory of the balls 807 in different plays of the game, even though the players may become very skilled at making an input to stop the ball launcher 805 (select a visual state of the visual depiction) at a desired angular orientation.

Although example implementations of the invention are described above mostly in terms of standalone games, it should be appreciated that the invention may be applied in any number of different gaming environments and/or in combination with other games. For example, games providing outcome distribution selection according to the present invention may be used as in-revenue or out-of-revenue tournament games or in side action games that are played in parallel or concurrently with one or more other games. Games employing outcome distribution selection may also be employed as community games in which results at one gaming machine affect a community of one or more other players at different gaming machines. Games employing outcome distribution selection may also employ additional features to enhance the player's gaming experience. For example, players may be allowed to save game symbols from one play (including trigger symbols) and apply the saved symbols to another play. This may be accomplished by freezing one or more reels for a given play of a reel-type game. Also, games employing outcome distribution selection may incorporate progressive prizes. For example, one or more prizes in the applicable pay table may comprise a respective progressive prize. Avatars are among other game features which may be used in connection with games employing outcome distribution selection. For example, an avatar may be used to indicate the selection of a given outcome distribution set for a play of the game. Trailing touch screen graphic effects such as those disclosed in U.S. Patent Application Publication No. 2012/0115599 may also be incorporated in games employing outcome distribution selection according to the present invention.

As used in the foregoing description and the following claims, the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above-described example embodiments are intended to illustrate the principles of the invention, but not to limit the scope of the invention. Various other embodiments and modifications to these preferred embodiments may be made by those skilled in the art without departing from the scope of the present invention.

1. A method for selecting an outcome distribution in a wagering game, the method including:
(a) through a display system of a gaming machine, displaying a visual depiction which varies over a range of visual states, each visual state being correlated to a respective outcome distribution from a set of different outcome distributions;
(b) receiving a player input through a player input system of the gaming machine, the player input selecting one of the visual states;
(c) applying the outcome distribution correlated to the selected visual state to randomly identify an outcome for a play of a game at the gaming machine; and
(d) awarding any prize correlated to the identified outcome, the prize being awarded through the gaming machine.

2. The method of claim 1 wherein the visual depiction includes a depiction of an element which oscillates back and forth across a range of angular orientations, and wherein each visual state is correlated to a respective angular orientation in the range of angular orientations.

3. The method of claim 1 wherein the visual depiction includes a depiction of an element which travels continuously along a path, and wherein each visual state is correlated to a respective position along the path.

4. The method of claim 1 wherein the visual depiction includes a depiction of a target area traversing a grid of grid locations, and wherein each visual state is correlated to a respective grid location.

5. The method of claim 4 wherein:
(a) each respective grid location is correlated to a respective outcome for a play of the game; and
(b) the outcome distribution correlated to each respective grid location includes the outcome correlated to that grid location and the respective outcome correlated to each of a number of grid locations adjacent to that grid location.

6. The method of claim 5 further including displaying the target area landing at the grid location correlated to the outcome which is identified for the play of the game at the gaming machine.

7. The method of claim 1 wherein each different outcome distribution has approximately the same expected prize value.

8. A gaming machine providing a wagering game, the gaming machine including:
(a) a display system;
(b) a player input system;
(c) at least one processor; and
(d) at least one memory device storing instructions executable by the at least one processor to:
(i) cause the display system to display a visual depiction which varies over a range of visual states, each visual state being correlated to a respective outcome distribution from a set of different outcome distributions;
(ii) receive a player input entered through a player input system of the gaming machine, the player input selecting one of the visual states;
(iii) apply the outcome distribution correlated to the selected visual state to randomly identify an outcome for a play of a game at the gaming machine; and
(iv) cause the display system to display an award of any prize correlated to the identified outcome.

9. The gaming machine of claim 8 wherein the visual depiction includes a depiction of an element which oscillates back and forth across a range of angular orientations, and wherein each visual state is correlated to a respective angular orientation in the range of angular orientations.

10. The gaming machine of claim 8 wherein the visual depiction includes a depiction of an element which travels continuously along a path, and wherein each visual state is correlated to a respective position along the path.

11. The gaming machine of claim 8 wherein the visual depiction includes a depiction of a target area traversing a grid of grid locations, and wherein each visual state is correlated to a respective grid location.

12. The gaming machine of claim 11 wherein:
(a) each respective grid location is correlated to a respective outcome for a play of the game; and
(b) the outcome distribution correlated to each respective grid location includes the outcome correlated to that grid location and the respective outcome correlated to each of a number of grid locations adjacent to that grid location.

13. The gaming machine of claim 12 wherein the instructions are also executable by the at least one processor to cause the display system to display the target area landing at the grid location correlated to the outcome which is identified for the play of the game at the gaming machine.

14. The gaming machine of claim 8 wherein each different outcome distribution has approximately the same expected prize value.

15. A program product stored on one or more non-transitory computer readable data storage devices, the program product including:
(a) player input program code executable by at least one processor to receive a player input entered through a player input system of a gaming machine;
(b) game program code executable by the at least one processor to
(i) cause a display system to display a visual depiction which varies over a range of visual states, each visual state being correlated to a respective outcome distribution from a set of different outcome distributions; and
(ii) apply the outcome distribution correlated to the selected visual state to randomly identify an outcome for a play of a game at the gaming machine; and
(c) payout program code executable by the at least one processor to award any prize correlated to the identified outcome, the prize being awarded through the gaming machine.

16. The program product of claim 15 wherein the visual depiction includes a depiction of an element which travels continuously along a path, and wherein each visual state is correlated to a respective position along the path.

17. The program product of claim 15 wherein the visual depiction includes a depiction of a target area traversing a grid of grid locations, and wherein each visual state is correlated to a respective grid location.

18. The program product of claim 17 wherein:
(a) each respective grid location is correlated to a respective outcome for a play of the game; and
(b) the outcome distribution correlated to each respective grid location includes the outcome correlated to that grid location and the respective outcome correlated to each of a number of grid locations adjacent to that grid location.

19. The program product of claim 18 wherein the game program code is also executable to cause the display system to display the target area landing at the grid location correlated to the outcome which is identified for the play of the game at the gaming machine.

20. The program product of claim 15 wherein each different outcome distribution has approximately the same expected prize value.
